(19) United States
(12) Patent Application Publication
(10) Pub. No.: US 2026/0180955 A1
(43) Pub. Date: Jun. 25, 2026

(54) METHODS, APPARATUSES, AND SYSTEMS FOR USER DEVICE VALIDATION

(71) Applicant: Comcast Cable Communications, LLC, Philadelphia, PA (US)

(72) Inventors: Robert Glenn DEEN, SIMI VALLEY, CA (US); Donald JONES, JR., BENNETT, CO (US)

(21) Appl. No.: 18/988,637

(22) Filed: Dec. 19, 2024

(51) Int. Cl. H04L 9/40

(52) U.S. Cl. CPC H04L 63/0272; H04L 63/10

(57) ABSTRACT

Systems, methods, and apparatuses are described for user validation. A user device may send a request to access content. A corresponding content delivery system may grant access to the content, and may send the user device a smart ad for display by the user device. The smart ad may include instructions for the user to send an advertisement response beacon to the content delivery system, which may provide information corresponding to the displaying of the advertisement by the user device. The advertisement response beacon may be sent outside of a virtual private network (VPN) environment, so the information provided in the advertisement response beacon may be indicative of whether the user device implemented a VPN environment when requesting access to the content. This information may facilitate accurate authorization of a user device to content.

### BACKGROUND

In content providing systems, certain content may be available to users based on a user's geographic location. For example, certain content may be blacked out to users in certain geographic locations, such as certain local content designated for a defined geographical range. Some user devices may attempt to mask the user's geographical location, which may provide the user with content the user is not permitted to access. For example, the user may request access to content via a virtual private network (VPN), which may provide identification information for the VPN on behalf of the user. The content platform may provide access based on the identification information of the VPN, which may also include content with geographical restrictions.

### SUMMARY

Systems, methods, and apparatuses are described for user device validation. A user device may send a request to access content to a content delivery system. The content delivery system may grant access to the content, and may send the user device advertisement data corresponding to the content. The advertisement data may include instructions for the user device to send advertisement responses to the content delivery system, which may provide information corresponding to the downloading of the advertisement by the user device. The advertisement responses may be sent outside of a virtual private network (VPN) environment, so the information provided in the advertisement responses may be indicative of whether the user device was utilizing a VPN environment when requesting access to the content. This information may facilitate accurate authorization of users to content, even if the user device is employing a VPN for communications.

### BRIEF DESCRIPTION OF DRAWINGS

The accompanying drawings, which are incorporated in and constitute a part of this specification, show embodiments and together with the description, serve to explain the principles of the methods and systems:

FIG. 1 shows an example system;

FIG. 2 shows an example computing system;

FIG. 3 shows an example system;

FIG. 4 shows an example system;

FIG. 5 shows an example method;

FIG. 6 shows an example method; and

FIG. 7 shows an example method.

### DETAILED DESCRIPTION

Methods, devices, and systems are described for validating user devices. In order for a device to gain access to content from a content delivery system, the user may provide login credentials and a request for access to content from the content delivery system. In some cases, the content delivery system may limit content provided to the device based on geographic location of the device, which the content delivery system may determine from information provided in the request for content access (e.g., by IP address provided in the request). However, some devices may employ VPN environments for communicating with the content delivery system, which may provide information in the request for content access indicative of geographic location for a corresponding VPN server instead of the device. The content delivery system may thus provide access to content based on the geographic location of the VPN server instead of the geographic location for the device, which may provide the device access to content that the device would typically be restricted from receiving.

According to the present disclosure, the content delivery system may cause the device to communicate outside of any VPN environment by advertisement information to the device. The advertisement information may include storage locations for advertisement content, or the advertisement information itself, for the device to download to display when the device accesses content. The advertisement information may also include instructions for the device to provide metrics to the content delivery system corresponding to the downloading of the advertisement content. The instructions may specify how the device is to provide the metrics, such as through a particular communication link, which may cause these communications to be conducted outside of ay VPN environment the device is employing. When the user provides these metrics, the device may also include information indicative of the device's geographic location, such as the device's IP address. The content delivery system can compare this information to the information received in the device's request for content access. If the content delivery system determines the compared information are different, the content delivery system may determine the device is employing a VPN environment, which may cause the content delivery to limit the device's access to content, or to request verification information from the device. This may allow for the content delivery system to identify a device's utilization of a VPN, which may provide for more accurate enforcement of restriction policies of content provided by the content delivery system.

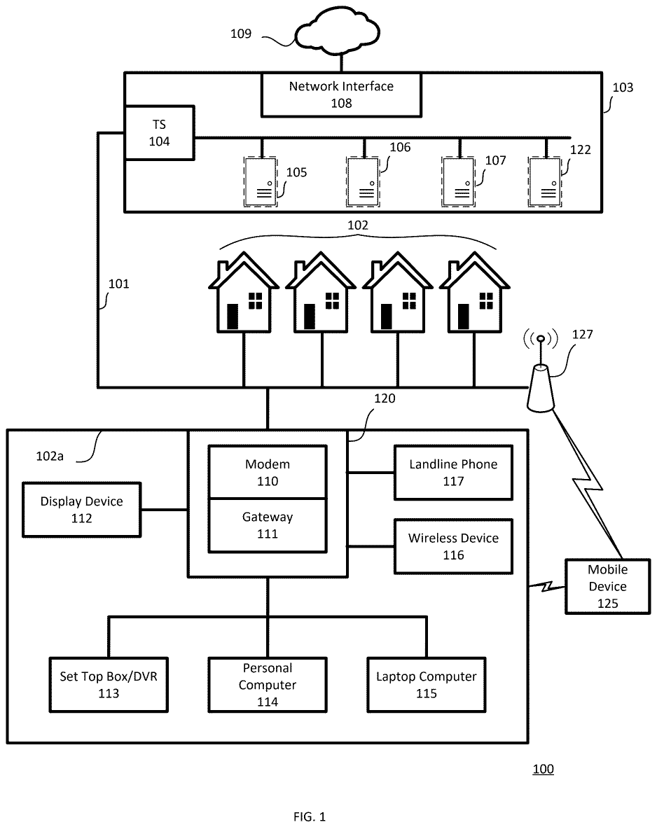

FIG. 1 shows an example communication network 100 in which features described herein may be implemented. The communication network 100 may be any type of information distribution network, such as satellite, telephone, cellular, wireless, etc. Examples may include an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may transmit downstream information signals and receive upstream information signals via the communication links 101. Each of the premises 102 may have equipment, described below, to receive, send, and/or otherwise process those signals.

The communication links 101 may originate from the local office 103 and may be split to exchange information signals with the various premises 102. The communication links 101 may include components not shown, such as splitters, filters, amplifiers, etc. to help convey the signal clearly. The communication links 101 may be coupled to an access point 127 (e.g., a base station of a cellular network, a Wi-Fi access point, etc.) configured to provide wireless communication channels to communicate with one or more mobile devices 125. The mobile devices 125 may include cellular mobile devices, and the wireless communication channels may be Wi-Fi IEEE 802.11 channels, cellular channels (e.g., LTE), and/or satellite channels.

The local office 103 may include a first interface 104, such as a termination system (TS). The first interface 104 may be a cable modem termination system (CMTS), which may be a computing device configured to manage communications between devices on the network of the communication links 101 and backend devices such as servers 105-107 and 122. The first interface 104 may be configured to place data on one or more downstream frequencies to be received by modems at the various premises 102, and to receive upstream communications from those modems on one or more upstream frequencies.

The local office 103 may also include one or more network interfaces 108 which may permit the local office 103 to communicate with various other external networks 109. The external networks 109 may include, for example, networks of Internet devices, telephone networks, cellular telephone networks, fiber optic networks, local wireless networks (e.g., WiMAX), satellite networks, a cloud network, and any other desired network, and the network interface 108 may include the corresponding circuitry needed to communicate on the external networks 109, and to other devices on the external networks. For example, the local office 103 may also or alternatively communicate with a cellular telephone network and its corresponding mobile devices 125 (e.g., cell phones, smartphone, tablets with cellular radios, laptops communicatively coupled to cellular radios, etc.) via the interface 108. Further, in some cases, any or all of the components of the local office 103 may be a part of a cloud network. For example, any of the servers of the local office 103 may be a cloud server or servers. In some cases, any or all of the servers shown in the local office 103 may be part of the external network 109, such as a cloud network 109.

The advertisement server 105 may provide advertisement content or associated data for download by a user device. The content server 106 may be one or more computing devices that are configured to provide content to devices at premises. This content may be, for example, video on demand movies, television programs, songs, text listings, web pages, articles, news, images, files, etc. The content server 106 may include software to locate and retrieve requested content and to initiate delivery (e.g., streaming) of the content to the requesting user(s) and/or device(s). The application server 107 may be a computing device configured to offer any desired service, and may execute various languages and operating systems (e.g., servlets and JSP pages running on Tomcat/MySQL, OSX, BSD, Ubuntu, Redhat, HTMLS, JavaScript, AJAX and COMET). For example, an application server may be responsible for collecting television program listings information and generating a data download for electronic program listings. Another application server may be responsible for monitoring user viewing habits and collecting that information for use in selecting advertisements. Yet another application server may be responsible for formatting and providing advertisement information to a user device. Yet another application server may receive login credentials of a user and validate the user for access to content (e.g., provided by a content server). Yet another application server may receive advertisement telemetry data from a user device. Another application server may be a gaming server configured to execute gaming programs. The local office 103 may include additional servers, including a controller server 122, additional push, content, and/or application servers, and/or other types of servers. Although shown separately, the advertisement server 105, the content server 106, the application server 107, the controller server 122, and/or other server(s) may be combined. The servers 105, 106, 107, and 122, and/or other servers, may be computing devices and may include memory storing data and also storing computer executable instructions that, when executed by one or more processors, cause the server(s) to perform steps described herein.

An example premises 102 a may include a second interface 120. The second interface 120 may include any communication circuitry used to communicate via one or more of the links 101. The second interface 120 may include a modem 110, which may include transmitters and receivers used to communicate via the links 101 with the local office 103. The modem 110 may be, for example, a coaxial cable modem (for coaxial cable lines of the communication links 101), a fiber interface node (for fiber optic lines of the communication links 101), twisted-pair telephone modem, cellular telephone transceiver, satellite transceiver, local Wi-Fi router or access point, or any other desired modem device. One modem is shown in FIG. 1, but a plurality of modems operating in parallel may be implemented within the second interface 120. The second interface 120 may include a gateway interface device 111. The modem 110 may be connected to, or be a part of, the gateway interface device 111. The gateway interface device 111 may be a computing device that communicates with the modem(s) 110 to allow one or more other devices in the premises 102a, to communicate with the local office 103 and other devices beyond the local office 103. The gateway interface device 111 may comprise a set-top box (STB), digital video recorder (DVR), a digital transport adapter (DTA), computer server, network-capable “smart” TVs with embedded processors, and/or any other desired computing device. The gateway interface device 111 may also include local network interfaces to provide communication signals to requesting entities/devices in the premises 102 a, such as display devices 112 (e.g., televisions), additional STBs or DVRs 113, personal computers/laptop 114, network-capable “smart” TVs, 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), etc.), landline phones 117 (e.g., Voice over Internet Protocol—VoIP phones), wireless “smart” TVs, and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11, IEEE 802.15), analog twisted pair interfaces, Bluetooth interfaces, and others.

One or more of the devices at a premises 102 a may be configured to provide wireless communications channels (e.g., IEEE 802.11 channels) to communicate with a mobile device 125. A modem 110 (e.g., access point) or a wireless device 116 (e.g., router, tablet, laptop, etc.) may wirelessly communicate with one or more mobile devices 125, which may be on-or off-premises.

Mobile devices 125 may communicate with a local office 103 including, for example, with the controller server 122. Mobile devices 125 may be cell phones, smartphones, tablets (e.g., with cellular transceivers), laptops (e.g., communicatively coupled to cellular transceivers), wearable devices (e.g., smart watches, electronic eye-glasses, etc.), or any other mobile computing devices. Mobile devices 125 may store, output, and/or otherwise use assets. An asset may be a video, a game, one or more images, software, audio, text, webpage(s), and/or other content. Mobile devices 125 may include Wi-Fi transceivers, cellular transceivers, satellite transceivers, and/or global positioning system (GPS) components.

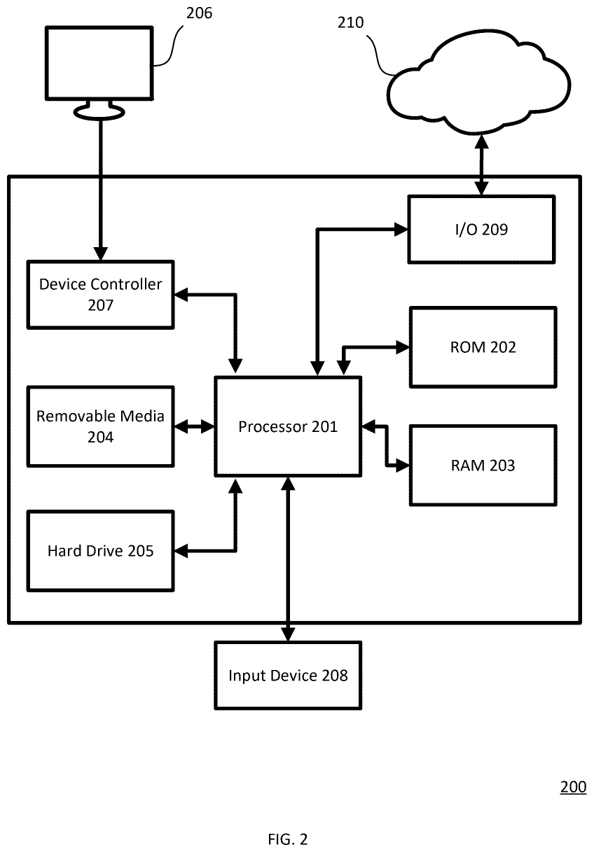

FIG. 2 shows hardware elements of a computing device that may be used to implement any of the computing devices discussed herein (e.g., the servers, devices, a controller server, end user device, receiving computing device, etc.). The computing device 200 may include one or more processors 201, which may execute instructions of a computer program to perform any of the functions described herein. The instructions may be stored in a read-only memory (ROM) 202, random access memory (RAM) 203, removable media 204 (e.g., a Universal Serial Bus (USB) drive, a compact disk (CD), a digital versatile disk (DVD)), and/or in any other type of computer-readable medium or memory. Instructions may also be stored in an attached (or internal) hard drive 205 or other types of storage media. The computing device 200 may include one or more output devices, such as a display 206 (e.g., an external television or other display device), and may include one or more output device controllers 207, such as a video processor. There may also be one or more user input devices 208, such as a remote control, keyboard, mouse, touch screen, microphone, graphical user interface (GUI), etc. The computing device 200 may also include one or more network interfaces, such as a network input/output (I/O) circuit 209 (e.g., a network card) to communicate with an external network 210, which in some cases may be an example of external network 109 of FIG. 1. The network input/output circuit 209 may be a wired interface, wireless interface, or a combination of the two. The network input/output circuit 209 may include a modem (e.g., a cable modem), and the external network 210 may include the communication links 101 discussed above, the external network 109, an in-home network, a network provider's wireless, coaxial, fiber, or hybrid fiber/coaxial distribution system (e.g., a DOCSIS network), or any other desired network.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein.

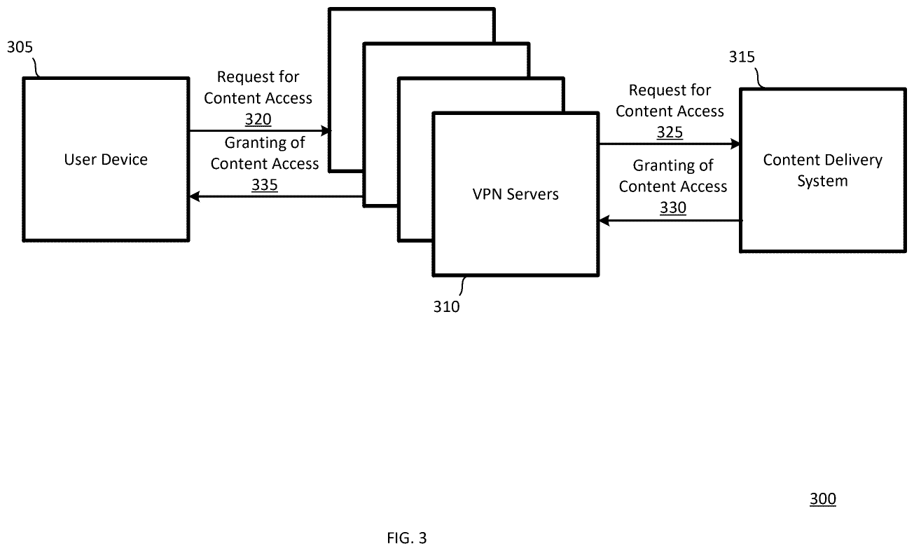

FIG. 3 shows an example system 300. The system 300 may include a user device 305, one or more VPN servers 310, and a content delivery system 315. The user device 305 may be an example of computing device 200, and may be an example of a device shown in FIG. 1. For example, the user device 305 may be a mobile device 125, a wireless device 116, a personal computer 114, a laptop computer 115, and/or the like.

The VPN servers 310 may provide for communications between the user device 305 and other entities, such as the content delivery system 315. The VPN servers 310 may receive communications from the user device 305 and may modify the communications to mask or remove identity information that may be indicative of the identity of the user device 305 or associated user. For example, the VPN server 310 may receive the communication from the user device 305 and may encrypt the communication. As another example, the VPN server 310 may receive the communication and may insert identification information of the VPN server, such as an IP address for the VPN server 305, in lieu of identification information of the user device 305.

In some cases, the VPN servers 310 may be geographically apart from the user device 305. For example, the VPN server 310 may be in a geographic zone of the user device 305, such as a different time zone, a different country, a different geographic region, and/or the like. Further, the identification information of the user device 305 and VPN server 310 may be based on the geographic region the respective device or server resides in. For example IP addresses can be based on the geographic region the respective device or server resides in.

The content delivery system 315 may authenticate and provide access to content. The content delivery system 315 may provide access to content based on the identification information received in a request for access to content. For example, the content delivery system 315 may enforce restriction policies associated with the content. The restriction policies may limit access to particular content. The restriction policies may be based on geographic region. For example, certain content may include blackout restrictions, where the content is unavailable to user devices in particular region (e.g., a local region). The content delivery system 315 may receive a request for access to content and may determine whether to grant access to the content based on the identification information included in the request for access. For example, in cases where the request for access to content includes an IP address indicating the requesting device resides in a given geographical location, the content delivery system 315 may determine whether to grant or deny access to the content based on the IP address.

As shown in FIG. 3, a user device 305 implementing the VPN server 310 may be able to circumvent any restriction policies associated with a content. The user device 305 may send a request for content access 320. The request for content access may include login credentials associated with a user profile, such as username and password information. In some cases, the request for content access may include content identification information that is being requested for access. For example, the content identification information may provide an identifier for a particular content (e.g., a content name or identification number). The request for access may also include identification information of the user device 305. For example, the request for access may include an IP address associated with the user device 305, which may be further associated with a geographic region the user device 305 is located.

The VPN server 310 may receive the request for content access from the user device 305, and may modify the request. The modification may include removing the identification information of the user device 305, such as an IP address of the user device 305 included in the request. The modification may also include adding identification information of the VPN server 310, such as an IP address associated with the VPN server 310. The VPN server 310 may send the modified request for content access 325 to the content delivery system 315. The modified request for content access may include the payload of the original request for content access sent by the user device 305, such as the login credentials, the content identification information, etc., but may include identification information of the VPN server 315 as opposed to the client device 305.

The content delivery system 315 may grant access to the content based on the information contained in the request for content access from the VPN server 310. The access granting may be based on an authentication of a corresponding user profile, such as via login credentials included in the request. In some cases, the user profile may already be previously granted access via a separate login attempt by the user device 305. The access granting may also be based on the identification information of the VPN server 310. For example, the content delivery system 315 may determine whether any restriction policy is associated with the requested content, such as a blackout policy or any geographical restriction. The content delivery system 315 may determine a geographical region the VPN server 310 resides in, and may determine whether the geographical region of the VPN server 310 is restricted accessing the requesting content. If no restriction is determined, the content delivery system 315 may grant access to the content, and may send a notification of granted access 330 to the VPN server 310 or information for accessing the content to the VPN server 310. The VPN server 310 may in turn send the granting of content access 335 to the user device 305, which may utilize the grant message for accessing the content.

However, as can be seen, the content accessing may be based on identification information of the associated VPN server 310, and not of the user device 305. Thus, the user device 305 may gain access to content the user device 305 would otherwise be restricted from accessing based on the implementation of the VPN.

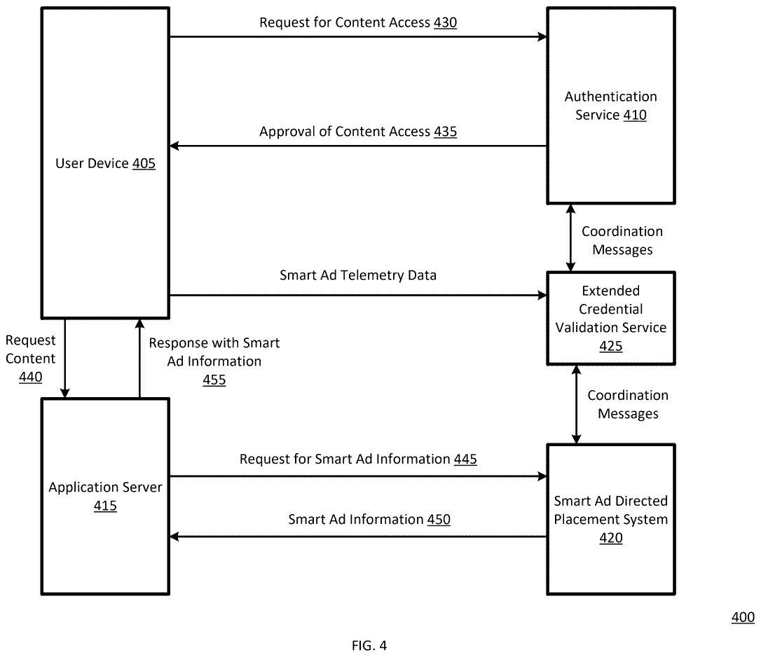

FIG. 4 shows an example system 400 according to the disclosure provided herein. The system 400 may include a user device 405, an authentication service 410, an application server 415, a smart ad directed placement system 420, and an extended credential validation service 425.

The user device 405 may be an example of the user device 305 shown in FIG. 3. The user device 405 may send a request for content access. The request for content access may include login credentials associated with a user profile, such as username and password information. In some cases, the request for content access may include content information for which the user device 305 is requesting access to.

In some cases, the request for content access 430 may pass through a VPN, such as the example shown in FIG. 3. The request for content access 430 may thus carry first identification information. The first identification information may be an IP address. In some cases, the first identification information may correspond to a VPN or VPN server, such as VPN server 310 of FIG. 3. In cases where a VPN is not used for sending the request for content access 430, the first identification information may correspond to the user device 405 (e.g., an IP address of the user device 405).

The authentication service 410 may receive the request for content access 430. The authentication service 410 may be a part of a content delivery system, such as the content delivery system 315 of FIG. 3. Based on the information included in the request, the authentication service 410 may grant access to the content. For example, the granting of access may be based on the login credentials received in the request for content access 430. The authentication service 410 may send to the user device a granting of access message 435. The granting of access message 435 may provide notice to the user device 405 that access had been granted. The granting of access message 435 may provide information for how the user device 405 is to access the content. For example, the granting of access message 435 may include a token or other validation indicator that the user device 405 may share to access the content. The granting off access message 435 may include identification or location information of the content to be accessed, such as an identification of a corresponding application server storing the content. The authentication service 410 may store the first identification information received in the request for access 430.

The user device 405 may send a request for the content 440 to an application server 415. The application server 415 may be capable of providing content requested by the user device 405. For example, the application server 415 may store or be capable of retrieving the content, or location information of the content. The request for the content 440 may include identification information of the content (e.g., a content name or title, chapter, etc.). In some cases, the request for the content 440 may include login information, which may be the login information the user device 405 provided to the authentication service 410 for authenticating the user device 405. In some cases, the user device 405 may provide a token provided by the authentication service 410. Similar to the communications between the user device 405 and the authentication service 410, the communications between the user device 405 and the application server 415 may pass through a VPN (e.g., in cases where the user device 405 is implementing a VPN).

The application server 415 may send a request for smart ad information 445 to a smart ad directed placement system 420. In some cases, the request for smart ad information 445 may include the authentication information of the user device, such as login credentials, a validation token, and/or the like. The smart ad directed placement system 420 may select advertisement content based on the authentication information, such as by identifying an associated user profile and selecting advertisement content based on the associated user profile. The smart ad directed placement system 420 may send smart advertisement information 450 to the application server 415. The smart advertisement information may include location information of the advertisement content. The smart advertisement information may include the advertisement content. The smart advertisement information may include instructions for ad metrics, which may cause the user device 420 to send metrics associated with the advertisement content to the content delivery system.

The application server 415 may send a response to the content request 455 to the user device 405. The response to the content request 455 may include the smart advertisement information corresponding to the content, for example, a URL(s) for advertisement content, instructions for sending ad metrics to the content delivery system. The response to the content request 455 may also include location information for the requested content, such as a URL(s) for the content.

The user device 405 may retrieve or display the requested content and advertisement content according to the response to the content request 455. For example, the advertisement content may include a smart ad, which may include the advertisement content and executable code elements. The executable code elements may include instructions for sending telemetry data associated with the advertisement content to the content delivery system. The user device 405 may send smart ad telemetry data 460 to the content delivery system, such as to the extended credential validation service 425. The smart ad telemetry data 460 may be sent as one or more advertisement response beacons. The smart ad telemetry data 460 may include metrics corresponding to the advertisement content provided or indicated by the application server 415. For example, the smart ad telemetry data 460 may include an indication of whether the advertisement content was successfully downloaded by the user 405. In some cases, the smart ad telemetry data 460 may include an indication of whether the advertisement content was successfully displayed by the user device 405. In some cases, the smart ad telemetry data 460 may include identifying information of the user device 405, such as an IP address, browser information, login state, application state information, etc. In some cases, the smart ad telemetry data 460 may include a unique identifier associated with a session for accessing the content. In some cases, the smart ad telemetry data 460 may include an identifier associated with the login credentials for accessing the content (e.g., provided to the content delivery system in the request for content access 430, the request for content 440, etc.).

The instructions associated with the advertisement content may cause the user device 405 to provide the smart ad telemetry data 460 external to a VPN. For example, the instructions may cause the user device 405 to send the smart ad telemetry data 460 via a specified application or browser, which may facilitate communications through networking services different than networking software of the user device 405 (e.g., where the networking software of the user device 405 may be utilizing a VPN for communications). In some cases, the instructions may cause the user device 405 to send the smart ad telemetry data 460 a specified network connection, which may include a virtualized physical network, link layer functions or IP transports such as TCP, UDP, QUIC, transports and interfaces such as WebTransport and WebSockets, and/or the like. The network connection may facilitate communications between the user device 405 and the content delivery system, which may be external to a VPN the user device 405 is implementing for communications.

In some cases, the instructions associated with the advertisement content may specify a network services configured for direct communication with network-based services that may be apart from network software of the user device 405. For example, the instructions may specify a Domain Name Services (DNS) for sending the smart ad telemetry data 460. The specified network services may cause the user device 405 to communicate outside of any VPN the user device 405 is implementing for communications.

The user device 405 may execute the advertisement content and the executable code elements, and may implement specified networking connections as alternatives to services or applications the user device 405 typically implements for communicating with external components. These alternative connections may provide for communication policies different than that of the typical (e.g., native) communication network access, which may result in differentiated communication behavior. The alternative communication policies may cause the user device 405 to communicate the ad metrics to the content delivery system external to any VPN the user device 405 implemented for communications, such as when the user device 405 sent request for content access 430 or the request for content 440.

The extended credential validation service 425 may determine second identification information from the smart ad telemetry data 460. In some cases, due to the instructions associated with the advertisement content, the second identification information may differ than the first identification information of received in the request for content access 430 or request for content 440. For example, the second identification information may include a second IP address, which may correspond to the user device 405. The first identification information may include a first IP address, which may purportedly also correspond to the user device 405. The content delivery system (e.g., the extended credential validation service, the authentication service 410, etc.) may compare the first and second identification information and may determine a difference between the two. For example, the content delivery system may determine a difference in the provided IP addresses, a difference in geographic locations associated with each IP address, etc. Based on this determination and comparison, the content delivery system may determine the user device 405 implemented a VPN when requesting access to the content, a likelihood the user device implemented a VPN.

In cases where the content delivery system determines a possibility the user device 405 is implementing a VPN, the content delivery system may update the permission granted to the user device for accessing content. For example, the content delivery system (e.g., via the authentication service 410) may send a follow-up request for login credentials from the user device 405. The content delivery system may request for additional verification, such as a multi-factor identification, which may provide additional identification information for the user device 405 (e.g., additional geographic information for the associated user profile). In some cases, the content delivery system may restrict access to content for the user device 405. For example, the content delivery system may suspend access to content, and may provide notification to the user device 405 of the suspension (e.g., in cases where the content delivery system determines a likelihood of unauthorized access). In another example, the content delivery system may restrict access to content based on the second identification information, such as through determining the geographical region the second identification information corresponds to, and enforcing content restriction policies according to the geographical region.

As discussed above, the content delivery system may include various components, entities, services, etc., such as the authentication service 410, the application server 415, the smart ad directed placement system 420, and the extended credential validation service 425. Further, the particular components shown in FIG. 4 of the content delivery system may differentiated as such, or may be compartmentalized or unified in various ways, and thus FIG. 4 is not to be read as an exhaustive format.

As a working example, a user device, such as a mobile phone, may request access to a webpage capable of displaying or playing content, such as a website with an embedded video player. The user inputs the URL of the website, and the website may request authentication of the mobile phone. The user inputs a username and password corresponding to a user profile, which the mobile phone then sends to the content delivery system. The message including the username and password may also include an IP address of the mobile phone. However, the mobile phone may also be implementing a VPN for communications. Thus, the login credential message(s) may be received by a corresponding VPN server, which may replace the mobile phone's IP address with an IP address of the VPN server. The VPN server may send this modified login credential message(s) to the content delivery system.

The content delivery system may validate the mobile phone based on validating the username and password provided by the mobile phone. The content delivery system may also store the IP address provided in the login communications with the mobile phone. The mobile, with access to the website, may select a video to play. The mobile phone may send the video request to the content delivery system, which may return the video content along with advertisement content for display within the webpage, such as an advertisement banner above, below, or to the side of the video player. The advertisement content may be packaged as a smart ad, which may include locations for accessing ad objects for display by the mobile phone, and a set of instructions for sending metrics related to the advertisement content to the content delivery system. The mobile phone may download the video content and advertisement content, and may display (or play) the respective contents. The mobile may also generate and send an advertisement beacon to the content delivery system according to the set of instructions provided in the smart ad. The advertisement beacon may include information requested in the set of instructions, such as an indication of whether the ad objects are successfully downloaded by the mobile phone, an indication of whether the ad objects are successfully displayed by the mobile phone, date and time of successful download, date and time of successful display, etc.

The advertisement beacon may be sent to the content delivery system according to the set of instructions of the smart ad. For example, the set of instructions may cause the mobile phone to send the advertisement beacon via a specified browser or application, via a specified communication port of the network system of the mobile phone, via a specified network interface, etc. The instructions for sending the advertisement beacon may include differing communication policies compared to communication policies the mobile device implemented for sending the login credentials, which may cause the mobile phone to send the advertisement beacon external to the VPN the mobile phone utilized for accessing the website. Additionally, the advertisement beacon may include the IP address of the mobile phone. As the mobile phone may send the advertisement beacon outside of the VPN, the VPN may not have the opportunity to remove the IP address of the mobile phone.

The content delivery system may receive the advertisement beacon, and may determine the IP address of the mobile phone. The content delivery system may compare the IP address received in the advertisement beacon with the IP address received with the login credentials, and the content delivery system may determine the IP addresses are different. The content delivery system may therefore determine a likelihood the mobile phone utilized a VPN for requesting access to the content, or may determine a likelihood the mobile phone is an unauthorized user. The content delivery system may restrict access to the content for the mobile phone, and may send notice of this restriction. The content delivery may request additional verification from the mobile phone, such as a request for multi-factor authentication.

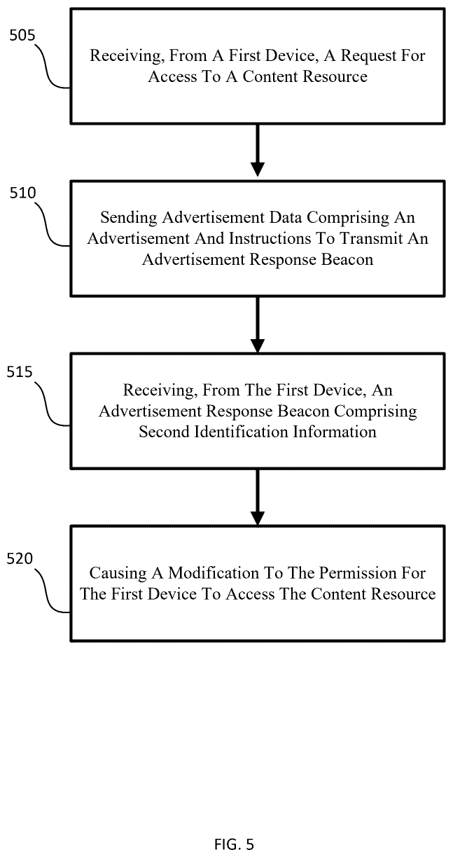

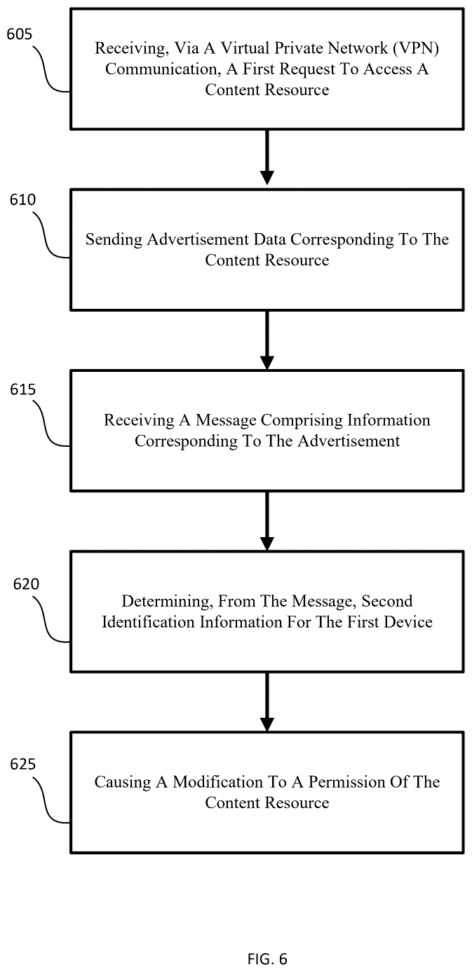

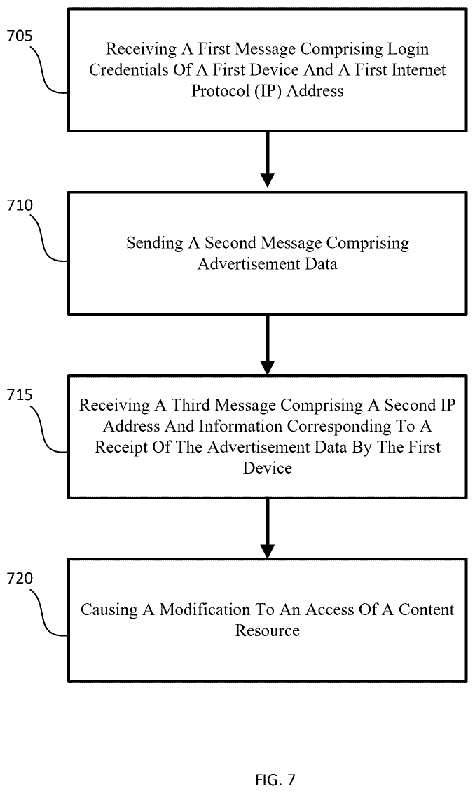

FIG. 5 shows an example method. The method may comprise a computer-implemented method for providing a service (e.g., a user validation service). A system or computing device, such as the system 100 of FIG. 1 or the components shown in FIG. 4, may be configured to perform the method of FIG. 5. The method may be performed in connection with the system 100 or 400. Any step or combination of steps of the method may be performed by a computing device, network device, network node, and/or client device, such as the devices shown in FIG. 1 and/or the components shown in FIG. 4. Any of the features of FIG. 5 may be combined with any of the features and/or steps of the methods of FIGS. 6 and 7, and the communications shown in FIG. 4.

At Step 505, a request for access to a content resource may be received. The request for access may be received from a first device. The request may include first identification information of the first device. The request for access may include login information corresponding to a user profile or the first device. For example, the login information may include username and password. The request for access may be for accessing the content resource through a website, such as a webpage including a video player. The first identification information may be an IP address The IP address may correspond to a VPN or VPN server in cases where the first device implements the VPN for sending the request for access. The content resource may be a video content or image content.

At Step 510, advertisement data may be sent to the first device. The advertisement data may include an advertisement and instructions to transmit an advertisement response beacon. The sending may be based on a permission for the first device to access the content resource. The advertisement data may include a smart ad. The advertisement data may include indications of storage locations for the advertisement. The advertisement may include a video advertisement or image advertisement for display by the first device. The instructions to transmit the advertisement response beacon may include instructions for including specified information corresponding to the advertisement. The specified information may include an indication of a successful download of the advertisement, an indication of a successful display of the advertisement by the first device, a date and time of successful download of the advertisement, a date and time of successful display of the advertisement, and/or the like. The instructions to transmit the advertisement response beacon may include instructions for implementing a specified network interface or application for sending the advertisement response beacon. The specified network interface or application may include a specified application, a specified web browser, a specified communication port of the first device, a specified network service, a specified networking element, a specified physical network, a specified link layer function, a specified network interface, a specified network IP transport, and/or the like. The permission for the first device to access the content resource may be further based on information included in the request for access to the content resource.

At Step 515, an advertisement response beacon may be received from the first device. The advertisement response beacon may include second identification information. The second identification information may be a second IP address. The second IP address may correspond to the first device. The advertisement response beacon may be received external to a VPN. The receiving of the advertisement response beacon external to the VPN may be caused by the instructions to transmit the advertisement response beacon. The second identification information may correspond to the first device.

At Step 520, a modification to the permission for the first device to access the content resource may be caused. The causing may be based on a difference between the first identification information and the second identification information. The first identification and the second identification information may include a first IP address and a second IP address. The first IP address may be different than the second IP address. The first identification and the second identification information may correspond to a first geographic and a second geographic region, respectively. The first geographic region may be different than the second geographic region. The modification may include a suspension of access to content by the first device. The modification may include a request for additional authentication information corresponding to the first device. The modification may include determining whether a restriction policy, such as a geographical restriction, is associated with the requested content resource, and enforcing the restriction based on the second identification information.

FIG. 6 shows an example method. The method may comprise a computer-implemented method for providing a service (e.g., a user validation service). A system or computing device, such as the system 100 of FIG. 1 or the components shown in FIG. 4, may be configured to perform the method of FIG. 6. The method may be performed in connection with the system 100 or 400. Any step or combination of steps of the method may be performed by a computing device, network device, network node, and/or client device, such as the devices shown in FIG. 1 and/or the components shown in FIG. 4. Any of the features of FIG. 6 may be combined with any of the features and/or steps of the methods of FIGS. 5 and 7, and the communications shown in FIG. 4.

At Step 605, a first request to access a content resource may be received. The first request may be received via a VPN communication. The first request may include first identification information for the first device. The first request may include login information corresponding to a user profile or the first device. For example, the login information may include a username and password. The firs request may be for accessing the content resource through a website, such as a webpage including a video player. The first identification information may include an IP address. The IP address may correspond to a VPN or VPN server in cases where the first device implements the VPN for sending the request for access. The content resource may be a video content or image content.

At Step 610, advertisement data may be sent to the first device. The advertisement data may correspond to the content resource. The advertisement data may include an advertisement and instructions to transmit an advertisement response beacon. The sending may be based on a permission for the first device to access the content resource. The advertisement data may include a smart ad. The advertisement data may include indications of storage locations for the advertisement. The advertisement may include a video advertisement or image advertisement for display by the first device. The instructions to transmit the advertisement response beacon may include instructions for including specified information corresponding to the advertisement. The specified information may include an indication of a successful download of the advertisement, an indication of a successful display of the advertisement by the first device, a date and time of successful download of the advertisement, a date and time of successful display of the advertisement, and/or the like. The instructions to transmit the advertisement response beacon may include instructions for implementing a specified network interface or application for sending the advertisement response beacon. The specified network interface or application may include a specified application, a specified web browser, a specified communication port of the first device, a specified network service, a specified networking element, a specified physical network, a specified link layer function, a specified network interface, a specified network IP transport, and/or the like. The permission for the first device to access the content resource may be further based on information included in the first request for access to the content resource.

At Step 615, a message comprising information corresponding to the advertisement may be received from the first device. The message may include an advertisement response beacon. The message may include an indication of a successful download of the advertisement, an indication of a successful display of the advertisement by the first device, a date and time of successful download of the advertisement, a date and time of successful display of the advertisement, and/or the like. The message may be received external to a VPN. The receiving of the message external to the VPN may be caused by the instructions to transmit the message. At Step 620, second identification information for the first device may be determined from the message. The second identification information may be a second IP address.

At Step 625, a modification to a permission of the content resource may be caused to be modified based on the second identification information. The causing may be based on a difference between the first identification information and the second identification information. The first identification and the second identification information may include a first IP address and a second IP address. The first IP address may be different than the second IP address. The first identification and the second identification information may correspond to a first geographic and a second geographic region, respectively. The first geographic region may be different than the second geographic region. The modification may include a suspension of access to content by the first device. The modification may include a request for additional authentication information corresponding to the first device. The modification may include determining whether a restriction policy, such as a geographical restriction, is associated with the requested content resource, and enforcing the restriction based on the second identification information.

FIG. 7 shows an example method. The method may comprise a computer-implemented method for providing a service (e.g., a user validation service). A system or computing device, such as the system 100 of FIG. 1 or the components shown in FIG. 4, may be configured to perform the method of FIG. 7. The method may be performed in connection with the system 100 or 400. Any step or combination of steps of the method may be performed by a computing device, network device, network node, and/or client device, such as the devices shown in FIG. 1 and/or the components shown in FIG. 4. Any of the features of FIG. 7 may be combined with any of the features and/or steps of the methods of FIGS. 5 and 6, and the communications shown in FIG. 4.

At Step 705, a first message may be received. The first message may include login credentials of a first device. The first message may include a first IP address. The first message may be a request for access to a content resource. The first message may be received from a first device. The login information may correspond to a user profile or the first device. For example, the login information may include username and password. The first message may be for accessing the content resource through a website, such as a webpage including a video player. The IP address may correspond to a VPN or VPN server in cases where the first device implements the VPN for sending the first message. The content resource may be a video content or image content.

At Step 710, a second message may be sent to the first device. The second message may include advertisement data. The sending may be based on the login credentials. The advertisement data may include an advertisement and instructions to transmit an advertisement response beacon. The sending may be based on a permission for the first device to access the content resource. The advertisement data may include a smart ad. The advertisement data may include indications of storage locations for the advertisement. The advertisement may include a video advertisement or image advertisement for display by the first device. The instructions to transmit the advertisement response beacon may include instructions for including specified information corresponding to the advertisement. The specified information may include an indication of a successful download of the advertisement, an indication of a successful display of the advertisement by the first device, a date and time of successful download of the advertisement, a date and time of successful display of the advertisement, and/or the like. The instructions to transmit the advertisement response beacon may include instructions for implementing a specified network interface or application for sending the advertisement response beacon. The specified network interface or application may include a specified application, a specified web browser, a specified communication port of the first device, a specified network service, a specified networking element, a specified physical network, a specified link layer function, a specified network interface, a specified network IP transport, and/or the like. The permission for the first device to access the content resource may be further based on information included in the first message.

At Step 715, a third message may be received. The third message may be received based on the sending of the second message. The third message may include a second IP address. The third message may include information corresponding to a receipt of the advertisement data by the first device. The third message mya be an advertisement response beacon. The third message may be received external to a VPN. The receiving of the third message external to the VPN may be caused by the instructions to transmit the third message. The second IP address may correspond to the first device.

At Step 720, a modification to an access of a content resource may be caused. The causing may be based on the second IP address. The causing may be based on the second IP address being different than the first IP address. The first IP address and the second IP address may correspond to a first geographic and a second geographic region, respectively. The first geographic region may be different than the second geographic region. The modification may include a suspension of access to content by the first device. The modification may include a request for additional authentication information corresponding to the first device. The modification may include determining whether a restriction policy, such as a geographical restriction, is associated with the requested content resource, and enforcing the restriction based on the second identification information.

Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed:

1. A method comprising:
receiving, from a first device, a request for access to a content resource, wherein the request comprises first identification information of the first device;
sending, to the first device and based on a permission for the first device to access the content resource, advertisement data comprising an advertisement and instructions to transmit an advertisement response beacon;
receiving, from the first device, an advertisement response beacon comprising second identification information; and
causing, based on a difference between the first identification information and the second identification information, a modification to the permission for the first device to access the content resource.

2. The method of claim 1, wherein one or more of the first identification information and the second identification information comprises an Internet Protocol (IP) address.

3. The method of claim 1, wherein the request for access is received via a virtual private network (VPN), and the advertisement response beacon is received via a communication path external to the VPN.

4. The method of claim 1, wherein the request for access is received via a network server, and wherein the advertisement response beacon is received from the first device.

5. The method of claim 1, wherein the instructions to transmit the advertisement response beacon comprises instructions to transmit the advertisement response beacon via a specified communication port, a specified network layer, a specified transport protocol, a specified application transport layer, or a combination thereof.

6. The method of claim 1, wherein the advertisement response beacon comprises data corresponding to the display of the advertisement.

7. The method of claim 1, wherein the causing the modification to the permission for the first device to access the content resource further comprises: sending an authentication request to the first device.

8. The method of claim 1, wherein the causing further comprises:
terminating access to the content resource for the first device.

9. The method of claim 1, wherein the advertisement data comprises one or more of advertisement objects, advertisement video data, advertisement image data, and advertisement audio data.

10. The method of claim 1, further comprising:
validating, based on the first identification information, the first device; and
sending, to the first device, an indication of the validation.

11. The method of claim 1, wherein the content resource comprises a webpage.

12. A method comprising:
receiving, via a virtual private network (VPN) communication, a first request to access a content resource, wherein the first request comprises first identification information for a first device;
sending, based on the receiving and to the first device, advertisement data corresponding to the content resource;
receiving, from the first device, a message comprising information corresponding to the advertisement data;
determining, from the message, second identification information for the first device; and
causing, based on the second identification information for the first device, a modification to a permission of the content resource.

13. The method of claim 12, wherein one or more of the first identification information, the second identification information comprises an Internet Protocol (IP) address.

14. The method of claim 12, wherein the second identification information comprises identification information of a VPN server.

15. The method of claim 12, wherein the information corresponding to the advertisement data comprises an acknowledgement the advertisement data is received by the first device.

16. The method of claim 12, wherein the second identification information is different than the first identification information.

17. A method comprising:
receiving a first message comprising login credentials of a first device and a first Internet Protocol (IP) address;
sending, based on the login credentials and to the first device, a second message comprising advertisement data;
receiving, based on the sending of the second message, a third message comprising a second IP address and information corresponding to a receipt of the advertisement data by the first device; and
causing, based on the second IP address and for the first device, a modification to an access of a content resource.

18. The method of claim 17, wherein the first IP address corresponds to a virtual private network (VPN) server.

19. The method of claim 17, wherein the third message comprises an advertisement response beacon.

20. The method of claim 17, wherein the second IP address is different than the first IP address.
